(19) United States
(12) Patent Application Publication
(10) Pub. No.: US 2017/0285967 A1
(43) Pub. Date: Oct. 5, 2017

(54) MULTI-WARE SMART SSD

(71) Applicant: Samsung Electronics Co., Ltd., Suwon-si (KR)

(72) Inventors: Rajinikanth Pandurangan, Fremont, CA (US); Changho Choi, San Jose, CA (US)

(21) Appl. No.: 15/161,144

(22) Filed: May 20, 2016

Related U.S. Application Data
(60) Provisional application No. 62/314,920, filed on Mar. 29, 2016.

(51) Int. Cl. G06F 3/06

(52) U.S. Cl. CPC G06F 3/0611; G06F 3/064; G06F 3/0653; G06F 3/0659; G06F 3/0685; G06F 3/0688

(57) ABSTRACT

A solid state drive (SSD) includes a first memory; a second memory of a different type than the first memory; a third memory of a different type than the first memory and of a different type than the second memory; and a weight determiner for determining a weightage of externally supplied data, prior to storing the data in any of the first memory, the second memory, or the third memory, and for assigning the data to one of the first memory, the second memory, or the third memory based on the determined weightage.

### CROSS REFERENCE TO RELATED APPLICATIONS

This application claims priority to, and the benefit of, provisional Patent Application Ser. No. 62/314,920, filed Mar. 29, 2016, the entire contents of which are incorporated herein by reference.

### BACKGROUND

### 1. Field

Embodiments of the present invention relate to solid state drives (SSDs).

### 2. Description of the Related Art

In general, data stored in memory blocks of a system have varying levels of importance. The data can be classified into many different categories (critical data, less critical data, hot data, cold data, warm data, etc.). Traditionally, all data on a drive is stored in a single type of memory block. Memory blocks of a single type have the same or substantially similar characteristics. Further, different types of memory blocks may have different characteristics.

### SUMMARY

According to an aspect of embodiments of the present invention, a solid state drive (SSD) includes a plurality of different types of memory blocks (e.g., dynamic random-access memory (DRAM) blocks, static random-access memory (SRAM) blocks, parallel random-access memory (PRAM) blocks, dual port random-access memory (DPRAM) blocks, phase change random-access memory (PCRAM blocks), resistance random-access memory (RRAM) blocks, polymer random-access memory (PoRAM) blocks, magnetic random-access memory (MRAM) blocks, ferroelectric random-access memory (FRAM) blocks, multi-level cell (MLC) flash memory blocks, triple-level cell (TLC) flash memory blocks, single-level cell (SLC) flash memory blocks, quad-level cell (QLC) flash memory blocks, etc.). Based on a weightage (or based on a stream ID, temperature, etc.) of the data, the data may be stored in an appropriate type of memory blocks.

According to an embodiment of the present invention, a solid state drive (SSD) includes a first memory; a second memory of a different type than the first memory; a third memory of a different type than the first memory and of a different type than the second memory; and a weight determiner for determining a weightage of externally supplied data, prior to storing the data in any of the first memory, the second memory, or the third memory, and for assigning the data to one of the first memory, the second memory, or the third memory based on the determined weightage.

The first memory, the second memory, and the third memory may each be one of the following types of memory: dynamic random-access memory (DRAM); static random-access memory (SRAM); parallel random-access memory (PRAM); dual port random-access memory (DPRAM); phase change random-access memory (PCRAM); resistance random-access memory (RRAM); polymer random-access memory (PoRAM); magnetic random-access memory (MRAM); ferroelectric random-access memory (FRAM); multi-level cell (MLC) flash memory; triple-level cell (TLC) flash memory; single-level cell (SLC) flash memory; and quad-level cell (QLC) flash memory.

The first memory may be the DRAM. The second memory may be SLC the flash memory. The third memory may be the MLC flash memory.

The weight determiner may be configured to determine the weightage of the data based on data characteristics of the data.

The data characteristics may include one or more of: importance information; expected update frequency; expected access frequency; and size information.

The weight determiner may be configured to determine the weightage of the data based on a received stream ID.

According to another embodiment of the present invention, a solid state drive (SSD) includes a first memory; a second memory of a different type than the first memory; and a weight determiner for receiving a stream ID of data received from outside, prior to storing the data in either of the first memory or the second memory, and for storing the data in one of the first memory or the second memory based on the stream ID.

The first memory and the second memory each comprises one of the following types of memory: dynamic random-access memory (DRAM); static random-access memory (SRAM); parallel random-access memory (PRAM); dual port random-access memory (DPRAM); phase change random-access memory (PCRAM); resistance random-access memory (RRAM); polymer random-access memory (PoRAM); magnetic random-access memory (MRAM); ferroelectric random-access memory (FRAM); multi-level cell (MLC) flash memory; triple-level cell (TLC) flash memory; single-level cell (SLC) flash memory; and quad-level cell (QLC) flash memory.

The first memory may be the DRAM, and the second memory may be the SLC flash memory.

The SSD may further include a third memory of a different type than the first memory and of a different type than the second memory.

The first memory may be the DRAM. The second memory may be the SLC flash memory. The third memory may be the MLC flash memory.

The weight determiner may be configured to receive a stream ID of data received from outside, prior to storing the data in any of the first memory, the second memory, or the third memory, and is configured to store the data in one of the first memory, the second memory, or the third memory based on the stream ID.

According to an embodiment of the present invention, a method of storing data in a solid state drive (SSD) includes: receiving data for storing in the SSD; assigning a weightage to the data; and storing the data in either a first memory or a second memory based on the weightage, the first memory being a different type of memory than the second memory.

The first memory and the second memory each comprises one of the following types of memory: dynamic random-access memory (DRAM); static random-access memory (SRAM); parallel random-access memory (PRAM); dual port random-access memory (DPRAM); phase change random-access memory (PCRAM); resistance random-access memory (RRAM); polymer random-access memory (PoRAM); magnetic random-access memory (MRAM); ferroelectric random-access memory (FRAM); multi-level cell (MLC) flash memory; triple-level cell (TLC) flash memory; single-level cell (SLC) flash memory; and quad-level cell (QLC) flash memory.

The first memory may be the DRAM, and the second memory may be the SLC flash memory.

The method may further include receiving a stream ID corresponding to the data, wherein the assigning the weightage comprises assigning the weightage to the data based on the stream ID.

The method may further include receiving data characteristics of the data, wherein the assigning the weightage comprises assigning the weightage to the data based on the data characteristics.

The data characteristics comprise one or more of: importance information; expected update frequency; expected access frequency; and size information.

The method may further include receiving a stream ID corresponding to the data; and receiving data characteristics of the data, wherein the assigning the weightage comprises assigning the weightage to the data based on the stream ID and based on the data characteristics.

The storing the data may include storing the data in either the first memory, the second memory, or a third memory based on the weightage, the third memory being a different type of memory than the first memory and being a different type of memory than the second memory.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating an example of an electronic device according to example embodiments.

FIG. 2 is a block diagram illustrating a solid state drive (SSD) according to example embodiments.

FIG. 3 illustrates a method of storing data in an SSD according to example embodiments.

FIG. 4 illustrates another method of storing data in an SSD according to example embodiments.

### DETAILED DESCRIPTION

A traditional storage system places vital and non-vital data in the same type of memory blocks within the storage system. In general, most applications have different sets of data. The sets of data may be frequently updated, frequently accessed, less frequently updated but frequently accessed, less frequently accessed and less frequently updated, etc. For example, in a laptop, there are different types of data, such as data corresponding to journaling of the filesystem, data representing installed programs/applications (write once, read multiple times), user data, backup data, etc.

Different types of memory blocks (which may be referred to as media, memory, memory media, etc.) have been developed. Different types of memory blocks may demonstrate different characteristics. Some memory blocks provide rapid access time, some memory blocks provide increased storage capacity per cell, and some memory blocks provide increased endurance or lifetime. For example, dynamic random-access memory (DRAM) blocks, which are a type of volatile memory blocks, may have a longer lifetime than many other types of memory blocks (e.g., non-volatile flash memory blocks). Additionally, the different characteristics of different memory blocks come with different costs.

Further, single-level cell (SLC) flash memory blocks, or an SLC-type memory cell, may withstand more erase cycles than multi-level cell (MLC) flash memory blocks. Meanwhile, MLC memory blocks may withstand more erase cycles than triple-level cell (TLC) flash memory blocks, which in turn may withstand more erase cycles than quad-level cell (QLC) flash memory blocks.

Typical applications usually only access (e.g., write to, or read from) certain logical block addresses, which may be referred to as LBAs or blocks. However, access operations may trigger many internal block writes/reads, remaps, and erases, due to the nature of the storage media and its management. Because of frequent block erases and remaps, the more frequently flash devices are used, the faster the flash devices may lose life span due to wear leveling, and the faster the input-output (IO) performance may be reduced due to garbage collection. Additionally, it may not be cost effective to have an SSD based on a high capacity RAM.

When a mixture of different types of data (e.g., hot, medium, and cold data) is stored in the same type of flash pages, the write amplification factor (WAF) may increase on updates, and the lifespan of the corresponding flash memory blocks may decrease. Thus, the life of the SSD may decrease.

When data is not stored in a corresponding type of memory blocks based on its weightage, cost per value may not be properly utilized. Herein, weightage may be a factor that is based on the importance of the data, the temperature of the data, the access or write frequency of the data, the criticality of the data, the size of the data, the logical block address of the data, and/or the like.

Prices of SSDs vary depending on the class of the SSDs. For example, SLC based SSDs typically cost more than, and also perform better than, MLC- or TLC-based SSDs. With a mixture of different types of data, it may be difficult to determine which SSD provides the right performance-to-cost ratio.

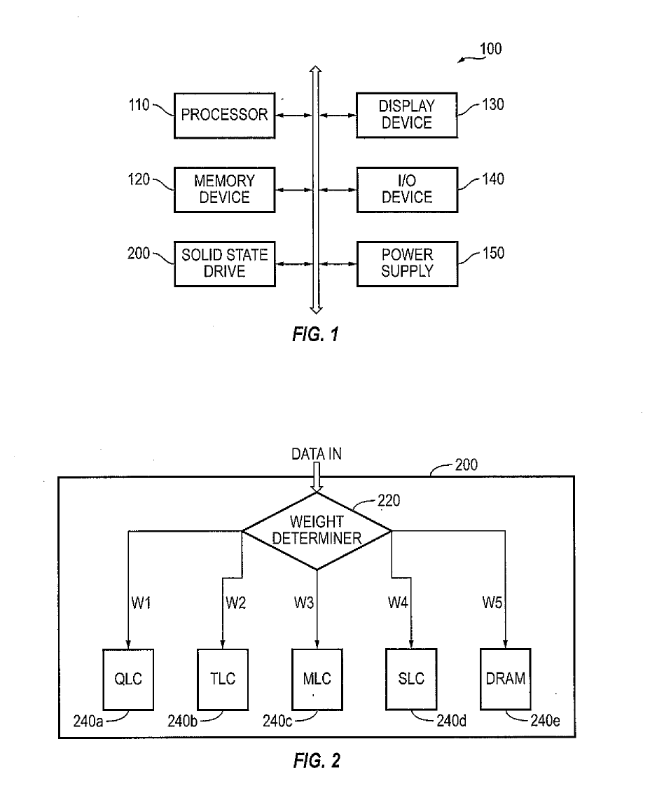

FIG. 1 is a block diagram illustrating an example of an electronic device according to example embodiments.

Referring to FIG. 1, an electronic device 100 may include a processor 110, a memory device 120, a display device 130, an input/output (I/O) device 140, a power supply 150, and a solid state drive (SSD) 200. The electronic device 100 may further include a plurality of ports for communicating, such as a video card, a sound card, a memory card, a universal serial bus (USB) device, a network card, other electronic devices, etc.

The processor 110 may perform various computing functions. The processor 110 may be an application processor (AP), a microprocessor, a central processing unit (CPU), etc. The processor 110 may be coupled to other components via an address bus, a control bus, a data bus, etc. Further, in some example embodiments, the processor 110 may be coupled to an extended bus, such as a peripheral component interconnection (PCI) bus.

The memory device 120 may store data for operations of the electronic device 100. For example, the memory device 120 may include at least one non-volatile memory device, such as an erasable programmable read-only memory (EPROM) device, an electrically erasable programmable read-only memory (EEPROM) device, a flash memory device, a phase change random-access memory (PCRAM) device, a resistance random-access memory (RRAM) device, a nano floating gate memory (NFGM) device, a polymer random-access memory (PoRAM) device, a magnetic random-access memory (MRAM) device, a ferroelectric random-access memory (FRAM) device, etc., and/or may include at least one volatile memory device, such as a dynamic random-access memory (DRAM) device, a static random-access memory (SRAM) device, a mobile dynamic random-access memory (mobile DRAM) device, etc.

The display device 130 may include any suitable type of display device. The I/O device 140 may include an input device, such as a keyboard, a keypad, a mouse, a touch screen, etc., and may also include an output device, such as a printer, a speaker, etc. The power supply 150 may supply power for operations of the electronic device 100.

According to example embodiments, the electronic device 100 may be any electronic device including the SSD 200. For example, the electronic device 100 may be a server, a laptop computer, a desktop computer, a smartphone, etc.

A relevant device(s) or component(s) according to embodiments of the present invention described herein may be implemented by using any suitable hardware (e.g., an application-specific integrated circuit), by using firmware (e.g., a DSP or FPGA), by using software, or by using a suitable combination of software, firmware, and hardware. For example, the various components of the relevant device(s) may be formed on one integrated circuit (IC) chip, or may be formed on separate IC chips. Further, the various components of the relevant device(s) may be implemented on a flexible printed circuit film, a tape carrier package (TCP), a printed circuit board (PCB), or may be formed on a same substrate as one or more circuits and/or other devices. Further, the various components of the relevant device(s) may be a process or thread that runs on one or more processors, in one or more computing devices, that execute computer program instructions, and that interacts with other system components for performing the various functionalities described herein. The computer program instructions may be stored in a memory that may be implemented in a computing device using a standard memory device 120, as discussed above. The computer program instructions may also be stored in other non-transitory computer readable media such as, for example, a CD-ROM, the solid state drive (SSD) 200, or the like. Also, it can be shown that the functionality of various computing devices may be combined or integrated into a single computing device, or the functionality of a particular computing device may be distributed across one or more other computing devices without departing from the spirit and scope of the exemplary embodiments of the present invention.

FIG. 2 is a block diagram illustrating an SSD according to example embodiments.

Referring to FIG. 2, the SSD 200 includes a weight determiner 220 and memory blocks 240 (e.g., memory blocks 240a to 240e). To store data in an appropriate type of memory block, in consideration of data characteristics, cost of the types of memory blocks, and memory performance, the SSD 200 includes different types of memory blocks 240 (e.g., QLC 240a, TLC 240b, MLC 240c, SLC 240d, and DRAM 240e). Accordingly, the SSD may be referred to as a multi-ware smart SSD.

As data importance varies from application to application, data may be assigned a weighting based on usage and importance of the data (e.g., based on data characteristics, such as access frequency, write frequency, importance of the data, etc.) and each type of data can be stored on an appropriate type of memory block according to its weighting.

By placing data in different memory blocks 240 based on the weighting of the data, the SSD 200 may provide high performance and endurance, while also providing cost savings.

The multi-stream concept is a concept of grouping data based on the properties of the data. These rights have various properties. A multi-streaming capable host system allows data to be grouped together into different streams. Data of a similar property (e.g., data having similar lifetimes) may be grouped together in the same stream. According to some embodiments of the present invention, data within the same stream are stored in the same type of memory block, and may be stored in the same particular memory block 240.

When the SSD 200 of the present embodiment receives an 10 request along with a stream ID of the data (DATA IN), the weight determiner 220 may accordingly make use of the different types of memory blocks to provide better endurance, cost effectiveness, and performance. The weight determiner 220 may assign a weightage (e.g., one of weightages W1, W2, W3, W4, or W5) for the input data based on the stream ID. The data may then be stored in memory blocks 240 (e.g., QLC 240a, TLC 240b, MLC 240c, SLC 240d, and/or DRAM 240e) based on the stream ID/weightage.

When the SSD 200 receives an IO request along with information corresponding to hotness/temperature of, and/or importance of, the data (DATA IN), the weight determiner 220 may accordingly make use of the different types of memory blocks to provide better endurance, cost effectiveness, and performance. The weight determiner 220 may determine or assign weightage (e.g., W1, W2, W3, W4, or W5) for the data. The data is then stored in particular ones of the memory blocks 240 (e.g., QLC 240a, TLC 240b, MLC 240c, SLC 240d, and/or DRAM 240e) based on the determined weightage or assigned weightage.

When a stream ID (or tag) is provided from a host, or when at least one data characteristic (e.g., data access frequency) is provided, a detection algorithm inside the weight determiner 220 may assign certain data to capacitor-backed memory blocks (e.g., DRAM memory blocks), and may assign the remaining data to appropriate flash memory blocks according to the characteristics of the data and the memory blocks 240. By placing frequently accessed data in capacitor-backed memory blocks, the 10 performance, as well as the life of the SSD, may be increased.

Similarly, depending on the characteristics of the data, data may be stored into SLC, MLC, TLC, or QLC flash memory blocks (or NAND flash memory blocks). The types of memory blocks 240 are not limited hereto, and embodiments of the present invention may have other suitable types of memory blocks. While FIG. 2 shows the SSD 200 including five types of memory blocks 240 (four types of flash memory blocks and one type of RAM memory blocks), the present invention is not limited thereto, and the SSD 200 may be suitably designed and built with two or more types of memory blocks 240.

In some embodiments, when capacitor-backed memory blocks (e.g., super capacitor-backed memory blocks) are used, to prevent data loss, data may be flushed into flash memory blocks when the SSD 200 loses power, and the data may be retrieved from the flash memory blocks when power is restored to the SSD 200. Additionally, battery-backed memory blocks may be used in place of, or in addition to, the capacitor-backed memory blocks.

Further, according to embodiments of the present invention, a typical DRAM SSD buffer may be provided in addition to the memory blocks of DRAM 240e, but the present invention is not limited thereto and the DRAM 240e may both serve as memory blocks and serve as an SSD buffer. In other embodiments, the typical DRAM SSD buffer may be provided, in addition to DRAM 240e. When the DRAM 240e is used as both memory blocks and as an SSD buffer, the DRAM 240e may have a large enough capacity to provide functions of both.

According to some embodiments of the present invention, data placement within the various types of memory blocks 240 may be improved depending on capacity and an expected number of erases.

Software components (or software operations) like flash translation layers, garbage collection, over provisioning, wear leveling, and logical-to-physical page mapping may be appropriately modified to handle the different types of memory block 240 (e.g., different types of non-volatile memory blocks). For example, in some embodiments, garbage collection may be handled differently for a MLC block than it is for an SLC block. Software components of a solid state drive (SSD) 200 including different flash memory blocks, according to an embodiment of the present invention, may perform different garbage collection methods, steps, of frequency, depending on the type of flash memory block for which garbage collection is being performed.

Further, according to some embodiments, when a certain type of memory block 240 is full or close to maximum capacity, the weight determiner 220 may assign a different weightage, or stream ID, to data that would have been assigned the weightage or stream ID of the type of memory block that is either full or close to maximum capacity. This alternate assignment may be made to a type of memory block that is similar (or close in characteristics) to the type of memory block that is full/close to maximum capacity, and this alternate assignment may take into account information, such as the fill level of the other types of memory blocks 240, and such as the data characteristics of the data (e.g., certain warm data may be closer to warm-hot data than to cold-warm data, and accordingly may be re-assigned to the hot data stream or to a media type reserved for hot data).

Further, capacities of the different types of memory blocks (or the quantity of different types of memory blocks) within the SSD 200 may be the same or the capacities (or quantities) may vary. For example, in some embodiments, the SSD 200 may include a relatively small amount of DRAM memory blocks, a larger amount of SLC memory blocks, and a much larger amount of MLC memory blocks. In some embodiments, the SSD 200 may include equal capacities of SLC memory blocks and TLC memory blocks.

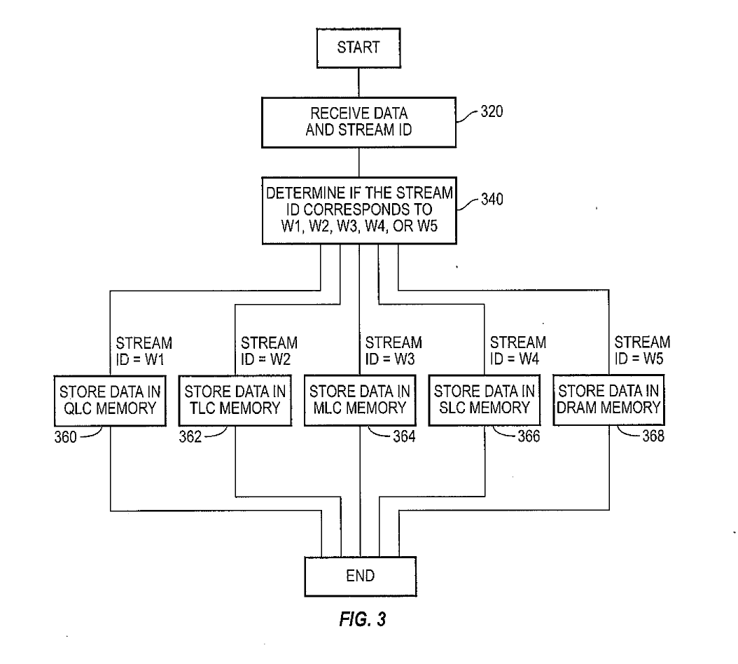

FIG. 3 illustrates a method of storing data in an SSD according to example embodiments.

According to the method shown in FIG. 3, an SSD (e.g., the SSD 200 of FIG. 2) may receive data (e.g., externally supplied data) and a stream ID from a host (320). The

SSD may determine which of the types of memory blocks, or which of the weightages of the types of memory blocks (e.g., W1, W2, W3, W4, or W5), correspond to the stream ID (340). According to some embodiments of the present invention, the stream ID may be in a range from 1 to 10, for example.

In the present embodiment, when the stream ID corresponds to a first weightage W1 (e.g., cold data), the data may be stored in QLC memory blocks (e.g., memory block(s) 240a of FIG. 2) (360). When the stream ID corresponds to a second weightage W2 (e.g., cold-warm data), the data may be stored in TLC memory blocks (e.g., memory block(s) 240b of FIG. 2) (362). When the stream ID corresponds to a third weightage W3 (e.g., warm data), the data may be stored in MLC memory blocks (e.g., memory block(s) 240c of FIG. 2) (364). When the stream ID corresponds to a fourth weightage W4 (e.g., warm-hot data), the data may be stored in SLC memory blocks (e.g., memory block(s) 240d of FIG. 2) (366). When the stream ID corresponds to a fifth weightage W5 (e.g., hot data), the data may be stored in DRAM memory blocks (e.g., memory block(s) 240e of FIG. 2) (368).

In this way, data that is accessed more frequently (e.g., hotter data) may be placed in memory blocks that wear out less quickly and/or have faster access times, but are more expensive, and data that is accessed less frequently (e.g., colder data) may be placed in memory blocks that wear out more quickly and/or have slower access times, but are cheaper.

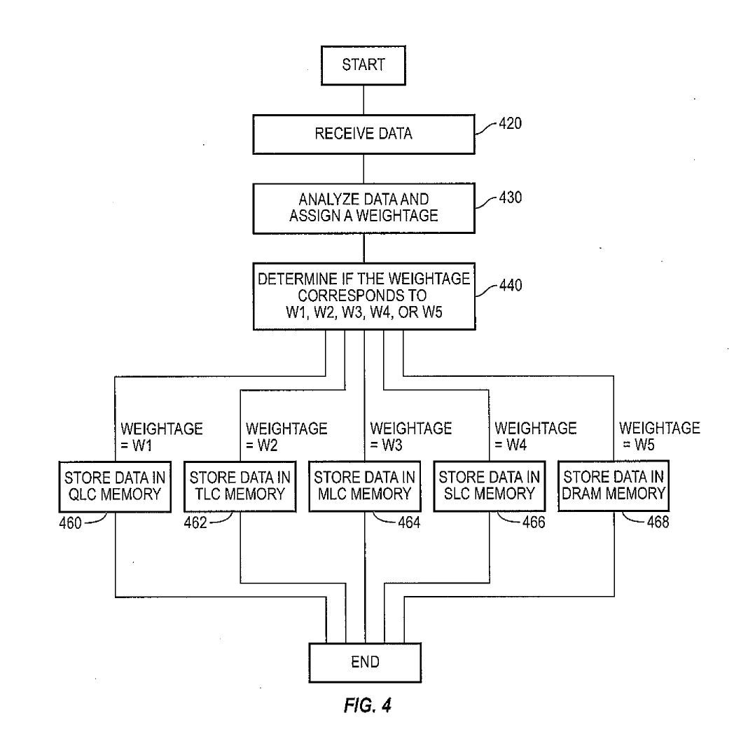

FIG. 4 illustrates another method of storing data in an SSD according to example embodiments.

According to the method shown in FIG. 4, an SSD (e.g., the SSD 200 of FIG. 2) may receive data (e.g., externally supplied data) and may also receive at least one data characteristic from a host (420). The SSD may use a weighing algorithm to assign a weightage to the data (430). The SSD may determine which of the types of memory blocks, or which of the weightages of the types of memory blocks (e.g., W1, W2, W3, W4, or W5), correspond to the weightage of the data (440).

The weighing algorithm may be any suitable weighing algorithm, for example, an algorithm that takes into account some or all of the data characteristics such as data temperature, frequency information, importance information, criticality information, size information, logical block address, and/or the like.

In the present embodiment, when the weightage corresponds to a first weightage W1 (e.g., cold data), the data may be stored in QLC memory blocks (e.g., memory block(s) 240a of FIG. 2) (460). When the weightage corresponds to a second weightage W2 (e.g., cold-warm data), the data may be stored in TLC memory blocks (e.g., memory block(s) 240b of FIG. 2) (462). When the weightage corresponds to a third weightage W3 (e.g., warm data), the data may be stored in MLC memory blocks (e.g., memory block(s) 240c of FIG. 2) (464). When the weightage corresponds to a fourth weightage W4 (e.g., warm-hot data), the data may be stored in SLC memory blocks (e.g., memory block(s) 240d of FIG. 2) (466). When the weightage corresponds to a fifth weightage W5 (e.g., hot data), the data may be stored in DRAM memory blocks (e.g., memory block(s) 240e of FIG. 2) (468).

The method of FIG. 4 may differ from the method of FIG. 3 in that, in the method of FIG. 3, the SSD receives a stream ID from a host and, in the method of FIG. 4, the SSD may receive at least one data characteristic.

According to some embodiments of the present invention, a single SSD may be capable of performing both the method of FIG. 3 and the method of FIG. 4, or the SSD may take into account the stream ID from the host, in addition to the at least one data characteristic, to determine the weightage.

When a host is capable of multi-streaming data to the SSD (e.g., providing a streaming ID to the SSD with the data), the SSD may use the stream ID to assign the data to a certain type of memory block(s) within the SSD, or the SSD may use the stream ID and data characteristics to assign the data to a certain type of memory block(s) within the SSD. When a host is not capable of multi-streaming data to the SSD, or simply fails to provide a streaming ID to the SSD with the data for whatever reason, the SSD may use data characteristics (e.g., read frequency, write frequency, etc.) to assign the data to a certain type of memory block(s) within the SSD.

According to embodiments of the present invention, data characteristics provided to the SSD and used in determining weightage may include, but are not limited to, data temperature (such as hot data, warm data, cold data, etc.), frequency information or expected frequency information (such as frequently updated and frequently accessed data, less frequently updated and frequently accessed data, frequently updated and less frequently accessed data, less frequently updated and less frequently accessed data, etc.), importance information (such as important data, less important data, non-important data, etc.), criticality information (such as critical data, less critical data, non-critical data, etc.), size information (such as large size data, medium size data, small size data, etc.), logical block address, etc.

Examples of important data may be the operating system files or an email marked important and an example of unimportant data may be metadata for a picture or video file. An example of critical data may be research data and an example of non-critical data may be temporary Internet files.

It will be understood that, although the terms “first,” “second,” “third,” etc., may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could tie termed a second element, component, region, layer, or section without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” “one of,” and “selected from,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Furthermore, “connection,” “connected,” etc., may also refer to “electrical connection,” “electrically connected,” etc., depending on the context in which such terms are used as would be understood by those skilled in the art. When an element or layer is referred to as being “directly on,” “directly connected to,” “directly coupled to,” “directly connected with,” “directly coupled with,” or “immediately adjacent to” another element or layer, there are no intervening elements or layers present.

As used herein, “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

According to an aspect of embodiments of the present invention, a solid state drive (SSD) includes a plurality of different types of memory blocks (e.g., DRAM, SRAM, PRAM, DPRAM, PCRAM, RRAM, PoRAM, MRAM, FRAM, MLC, TLC, SLC, QLC, etc.). Based on the weightage, stream ID, temperature, etc. of the data, the data may be stored in an appropriate type of memory block.

Although this invention has been described with regard to certain specific embodiments, those skilled in the art will have no difficulty devising variations of the described embodiments, which in no way depart from the scope and spirit of the present invention. Furthermore, to those skilled in the various arts, the invention itself described herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents.

What is claimed is:

1. A solid state drive (SSD) comprising:
a first memory;
a second memory of a different type than the first memory;
a third memory of a different type than the first memory and of a different type than the second memory; and
a weight determiner for determining a weightage of externally supplied data, prior to storing the data in any of the first memory, the second memory, or the third memory, and for assigning the data to one of the first memory, the second memory, or the third memory based on the determined weightage.

2. The SSD of claim 1, wherein the first memory, the second memory, and the third memory each comprise one of the following types of memory:
dynamic random-access memory (DRAM);
static random-access memory (SRAM);
parallel random-access memory (PRAM);
dual port random-access memory (DPRAM);
phase change random-access memory (PCRAM);
resistance random-access memory (RRAM);
polymer random-access memory (PoRAM);
magnetic random-access memory (MRAM);
ferroelectric random-access memory (FRAM);
multi-level cell (MLC) flash memory;
triple-level cell (TLC) flash memory;
single-level cell (SLC) flash memory; and
quad-level cell (QLC) flash memory.

3. The SSD of claim 2,
wherein the first memory comprises the DRAM,
wherein the second memory comprises the SLC flash memory, and
wherein the third memory comprises the MLC flash memory.

4. The SSD of claim 1, wherein the weight determiner is configured to determine the weightage of the data based on data characteristics of the data.

5. The SSD of claim 4, wherein the data characteristics comprise one or more of:
importance information;
expected update frequency;
expected access frequency; and
size information.

6. The SSD of claim 1, wherein the weight determiner is configured to determine the weightage of the data based on a received stream ID.

7. A solid state drive (SSD) comprising:
a first memory;
a second memory of a different type than the first memory; and
a weight determiner for receiving a stream ID of data received from outside, prior to storing the data in either of the first memory or the second memory, and for storing the data in one of the first memory or the second memory based on the stream ID.

8. The SSD of claim 7, wherein the first memory and the second memory each comprises one of the following types of memory:
dynamic random-access memory (DRAM);
static random-access memory (SRAM);
parallel random-access memory (PRAM);
dual port random-access memory (DPRAM);
phase change random-access memory (PCRAM);
resistance random-access memory (RRAM);
polymer random-access memory (PoRAM);
magnetic random-access memory (MRAM);
ferroelectric random-access memory (FRAM);
multi-level cell (MLC) flash memory;
triple-level cell (TLC) flash memory;
single-level cell (SLC) flash memory; and
quad-level cell (QLC) flash memory.

9. The SSD of claim 8,
wherein the first memory comprises the DRAM, and
wherein the second memory comprises the SLC flash memory.

10. The SSD of claim 7, further comprising:
a third memory of a different type than the first memory and of a different type than the second memory.

11. The SSD of claim 10,
wherein the first memory comprises the DRAM,
wherein the second memory comprises the SLC flash memory, and
wherein the third memory comprises the MLC flash memory.

12. The SSD of claim 10, wherein the weight determiner is configured to receive a stream ID of data received from outside, prior to storing the data in any of the first memory, the second memory, or the third memory, and is configured to store the data in one of the first memory, the second memory, or the third memory based on the stream ID.

13. A method of storing data in a solid state drive (SSD), the method comprising:
receiving data for storing in the SSD;
assigning a weightage to the data; and
storing the data in either a first memory or a second memory based on the weightage, the first memory being a different type of memory than the second memory.

14. The method of claim 13, wherein the first memory and the second memory each comprise one of the following types of memory:
dynamic random-access memory (DRAM);
static random-access memory (SRAM);
parallel random-access memory (PRAM);
dual port random-access memory (DPRAM);
phase change random-access memory (PCRAM);
resistance random-access memory (RRAM);
polymer random-access memory (PoRAM);
magnetic random-access memory (MRAM);
ferroelectric random-access memory (FRAM);
multi-level cell (MLC) flash memory;
triple-level cell (TLC) flash memory;
single-level cell (SLC) flash memory; and
quad-level cell (QLC) flash memory.

15. The method of claim 14,
wherein the first memory comprises the DRAM, and
wherein the second memory comprises the SLC flash memory.

16. The method of claim 13, further comprising:
receiving a stream ID corresponding to the data,
wherein the assigning the weightage comprises assigning the weightage to the data based on the stream ID.

17. The method of claim 13, further comprising:
receiving data characteristics of the data,
wherein the assigning the weightage comprises assigning the weightage to the data based on the data characteristics.

18. The method of claim 17, wherein the data characteristics comprise one or more of:
importance information;
expected update frequency;
expected access frequency; and
size information.

19. The method of claim 13, further comprising:
receiving a stream ID corresponding to the data; and
receiving data characteristics of the data,
wherein the assigning the weightage comprises assigning the weightage to the data based on the stream ID and based on the data characteristics.

20. The method of claim 13, wherein the storing the data comprises storing the data in either the first memory, the second memory, or a third memory based on the weightage, the third memory being a different type of memory than the first memory and being a different type of memory than the second memory.
